(19) United States
(12) Patent Application Publication
(10) Pub. No.: US 2023/0362452 A1
(43) Pub. Date: Nov. 9, 2023

(54) DISTRIBUTOR-SIDE GENERATION OF CAPTIONS BASED ON VARIOUS VISUAL AND NON-VISUAL ELEMENTS IN CONTENT

(71) Applicant: SONY GROUP CORPORATION, TOKYO (JP)

(72) Inventors: BRANT CANDELORE, POWAY, CA (US); ADAM GOLDBERG, FAIRFAX, VA (US)

(21) Appl. No.: 17/739,266

(22) Filed: May 9, 2022

(51) Int. Cl. H04N 21/488; H04N 21/439; G10L 15/26; G06F 16/783

(52) U.S. Cl. CPC H04N 21/4884; H04N 21/4394; G10L 15/26; G06F 16/7844

(57) ABSTRACT

A content distribution system and method for distribution-side generation of captions is disclosed. The content distribution system receives media content including video content and audio content associated with the video content and generates a first text based on a speech-to-text analysis of the audio content. The content distribution system further generates a second text that describes audio elements of a scene associated with the media content. The audio elements are different from a speech component of the audio content. The content distribution system further generates captions for the video content based on the first text and the second text and transmits the generated captions to an electronic device via an Over-the-Air (OTA) signal, via a cable, or via a streaming Internet connection.

### CROSS-REFERENCE TO RELATED APPLICATIONS/INCORPORATION BY REFERENCE

None

### FIELD

Various embodiments of the disclosure relate to generation of captions. More specifically, various embodiments of the disclosure relate to a content distribution system and method for generation of captions based on various visual and non-visual elements in media content.

### BACKGROUND

Advancements in accessibility technology and content streaming have led to an increase in use of subtitles and closed captions in on-demand content and linear television programs. Captions may be utilized by users, especially ones with a hearing disability to understand dialogues and scenes in a video. Typically, captions may be generated at the video source and embedded into the video stream. Alternatively, the captions, especially for live content, can be generated based on a suitable automatic speech recognition (ASR) for a speech-to-text conversion of an audio segment of the video. However, such captions may not always be flawless, especially if the audio is recorded in a noisy environment or if people in the video don't enunciate properly. For example, people can have a non-native or a heavy accent that can be difficult to process by a traditional speech-to-text conversion model. In addition, the background noises, e.g., that music is playing or baby crying, are left out. In relation to accessibility, users with a hearing disability may not always be satisfied by the generated captions.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A content distribution system and method for generation of captions based on various visual and non-visual elements in media content is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for generation of captions based on various visual and non-visual elements in content, in accordance with an embodiment of the disclosure.

FIG. 2 is a block diagram that illustrates a content distribution system of FIG. 1, in accordance with an embodiment of the disclosure.

FIGS. 3A and 3B are diagrams that illustrates an exemplary processing pipeline for generation of captions based on various visual and non-visual elements in content, in accordance with an embodiment of the disclosure.

FIG. 4A is a diagram that illustrates an exemplary scenario for generation of captions based on various visual and non-visual elements in content, in accordance with an embodiment of the disclosure.

FIG. 4B is a diagram that illustrates an exemplary scenario for generation of captions based on various visual and non-visual elements in content, in accordance with an embodiment of the disclosure.

FIG. 5 is a diagram that illustrates an exemplary scenario for generation of captions when a portion of audio content is unintelligible, in accordance with an embodiment of the disclosure.

FIG. 6 is a diagram that illustrates an exemplary scenario for generation of hand-sign symbols based on various visual and non-visual elements in content, in accordance with an embodiment of the disclosure.

FIG. 7 is a flowchart that illustrates exemplary operations for generation of captions based on various visual and non-visual elements in content, in accordance with an embodiment of the disclosure.

### DETAILED DESCRIPTION

The following described implementation may be found in the disclosed content distribution system and method for generation and distribution of captions based on various visual and non-visual elements in media content. Exemplary aspects of the disclosure provide a content distribution system (e.g., a server or a cluster of servers for content distribution), which may automatically generate captions (such as captions and hand-sign symbols associated with a sign language) based on visual and non-visual elements in media content. The content distribution system may be configured to receive media content, including video content and audio content associated with the video content. The received media content may be a pre-recorded media content or a live media content. The content distribution system may be configured to generate a first text based on a speech-to-text analysis of the audio content. In an embodiment, the first text may be generated further based on an analysis of lip movements in the video content.

The content distribution system may be configured to generate a second text which describes one or more audio elements of a scene associated with the media content. The one or more audio elements may be different from a speech component of the audio content. For example, that music is playing or a baby in crying. The content distribution system may be configured to generate captions for the video content, based on the generated first text and the generated second text. Thereafter, the content distribution system may be configured to transmit the generated captions to an electronic device via an Over-the-Air (OTA) or cable signal or via a streaming Internet connection. The captions may be transmitted as in-band data with a transport stream of media content or may be transmitted separately as out-of-band data.

While the disclosed content distribution system generates a first text based on the speech-to-text analysis and/or lip movement analysis of the media content, the disclosed content distribution system may use an AI model to analyze the audio and video content and generate the second text, based on analysis of various audio elements of the media content. By combining both the first text and the second text in the captions, the disclosed content distribution system may provide captions that enrich the spoken text (i.e., the first text) and provide contextual information about various audio elements that are typically observed by full-hearing viewers but not included in auto-generated captions.

To aid users with a hearing disability, the disclosed content distribution system may generate captions that include hand-sign symbols in a specific sign language (such as American Sign Language). Such symbols may be a representation of the captions generated based on the first text and the second text. To further help users with a hearing disability or intelligibility issues, the disclosed content distribution system may be configured to determine a portion of the audio content as unintelligible based on at least one of, but not limited to, a determination that the portion of the audio content is missing a sound, a determination that the speech-to-text analysis has failed to interpret speech in the audio content to a threshold level of certainty, a hearing disability or a hearing loss of a user associated with the electronic device, an accent of a speaker associated with the portion of the audio content, a loud sound or a noise in a background of an environment that includes the content distribution system, an inability of the user to hear sound at certain frequencies, and a determination that the portion of the audio content is noisy. Based on the determination that the portion of the audio content is unintelligible, the content distribution system may be configured to generate the captions.

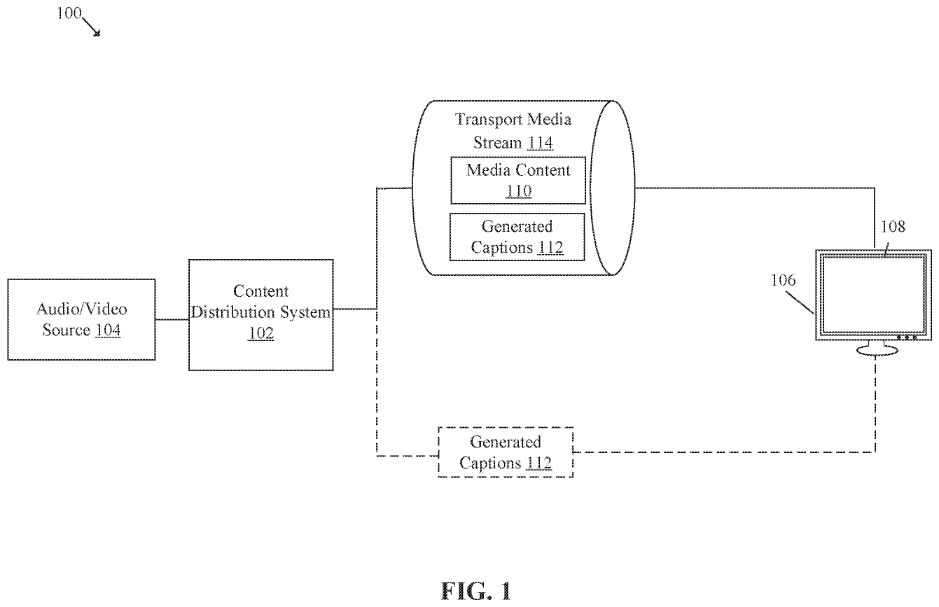

FIG. 1 is a block diagram that illustrates an exemplary network environment for generation of captions based on various visual and non-visual elements in content, in accordance with an embodiment of the disclosure. With reference to FIG. 1, there is shown a network environment 100. The network environment 100 may include a content distribution system 102, an audio/video (AV) source 104, and an electronic device 106. 4. The content distribution system 102 may communicate with the electronic device 106 via broadcast signals or via an Internet streaming connection.

The content distribution system 102 may include suitable logic, circuitry, interfaces, and/or code that may be configured to receive media content from the AV source 104 and may generate captions based on various speech elements and non-speech elements (e.g., audio elements) in the media content. The content distribution system 102 may include one or more servers to encode and package the media content to prepare a transport media stream. The generated captions may be transmitted to various electronic devices (e.g., the electronic device 106) as in-band data included with the transport media stream or as out-of-band data (which may be separate from the transport media stream). Example implementations of the content distribution system 102 may include, but are not limited to, a media server, a content delivery network, an Advanced Television System Committee (ATSC) or Society of Cable Telecommunications Engineers (SCTE) content, an ATSC, SCTE or Digital Video Broadcasting (DVB) delivery and signaling server, a broadcast gateway, an edge device connected to a media server, or a combination thereof.

In accordance with an embodiment, the content distribution system 102 may include a delivery sub-system and a transmission sub-system. The delivery sub-system may include at least one of content encoder(s), transcoder(s), packaging server(s), signaling server(s), broadcast gateway(s), Electronic Service Guide (ESG) server(s), NRT (Non-Real-Time) server(s), CDN, Ad server(s), and the like. The transmission sub-system may include at least one of digital exciter(s) (such as an ATSC, SCTE, or DVB exciter), a broadcast hardware, a transmitter station, and the like.

The AV source 104 may include suitable logic, circuitry, and interfaces that may be configured to deliver the media content to the content distribution system 102. The media content on the AV source 104 may include video content and audio content associated with the video content. For example, if the media content is a television program, then the audio content may include a background sound, non-speech content, and speech content.

In an embodiment, the AV source 104 may be implemented as a storage device which stores the media content. Examples of such an implementation of the AV source 104 may include, but are not limited to, a Pen Drive, a Flash USB Stick, a Hard Disk Drive (HDD), a Solid-State Drive (SSD), and/or a Secure Digital (SD) card. In another embodiment, the AV source 104 may be implemented as a media server, a broadcast station or a server of a content provider (such as a news studio), or a file hosting server.

In FIG. 1, the AV source 104 and the content distribution system 102 are shown as separate entities. However, the present disclosure may not be so limiting and in some embodiments, the functionality of the AV source 104 may be incorporated in its entirety or at least partially in the content distribution system 102, without departing from the scope of the present disclosure.

The electronic device 106 may include suitable logic, circuitry, interfaces, and/or code that may be configured to receive a transport media stream of media content from the content distribution system 102 via an OTA or cable signal or an Internet streaming connection. The electronic device 106 may also receive the captions as part of the stream or as an out-of-band data. Upon reception, the electronic device 106 may control a display device 108 to render the media content and the captions.

In accordance with an embodiment, the electronic device 106 may be a display-enabled media player and the display device 108 may be included in the electronic device 106. Examples of such an implementation of the electronic device 106 may include, but are not limited to, a television (TV), an Internet-Protocol TV (IPTV), a smart TV, a smartphone, a personal computer, a laptop, a tablet, a wearable electronic device, or any other display device with a capability to receive, decode, and play content encapsulated in broadcasting signals from cable or satellite networks, over-the-air broadcast, or Internet-based communication signals.

In another exemplary embodiment, the electronic device 106 may be a media player that may communicate with the display device 108, via a wired or a wireless connection. Examples of such an implementation of the electronic device 106 may include, but are not limited to, a digital media player (DMP), a micro-console, a TV tuner, an Advanced Television Systems Committee (ATSC) 3.0 tuner, a set-top-box, an Over-the-Top (OTT) player, a digital media streamer, a media extender/regulator, a digital media hub, a computer workstation, a mainframe computer, a handheld computer, a smart appliance, a plug-in device, and/or any other computing device with content streaming functionality.

The display device 108 may include suitable logic, circuitry, and interfaces that may be configured to display an output of the electronic device 106. The display device 108 may be utilized to display video content received from the electronic device 106. The display device 108 may be further configured to display captions for the video content. The display device 108 may be a unit that has be interfaced or connected with the electronic device 106, through an I/O port (such as a High-Definition Multimedia Interface (HDMI) port) or a network interface. Alternatively, the display device 108 may be an embedded component of the electronic device 106.

In at least one embodiment, the display device 108 may be a touch screen which may enable the user to provide a user-input via the display device 108. The display device 108 may be realized through several known technologies such as, but not limited to, at least one of a Liquid Crystal Display (LCD) display, a foldable or rollable display, a Light Emitting Diode (LED) display, a plasma display, or an Organic LED (OLED) display technology, or other display devices. In accordance with an embodiment, the display device 108 may refer to a display screen of a head mounted device (HMD), a smart-glass device, a see-through display, a projection-based display, an electro-chromic display, or a transparent display.

In operation, the content distribution system 102 may be configured to receive media content 110 from the AV source 104. The media content 110 may include video content and audio content associated with the video content. Typically, the media content can be any digital media that can be rendered, streamed, broadcasted, and/or stored on any electronic device or storage unit. Examples of the media content may include, but are not limited to, images (such as overlay graphics), animations (such as 2D/3D animations or motion graphics), audio/video data, conventional television programming (provided via traditional broadcast, cable, satellite, Internet, or other means), pay-per-view programs, on-demand programs (as in video-on-demand (VOD) systems), or Internet content (e.g., streaming media, downloadable media, Webcasts, etc.). In an embodiment, the received media content 110 may be a pre-recorded media content or a live media content. For example, a news studio may record a live show and may broadcast a recording of the live show (as the media content) to the content distribution system 102.

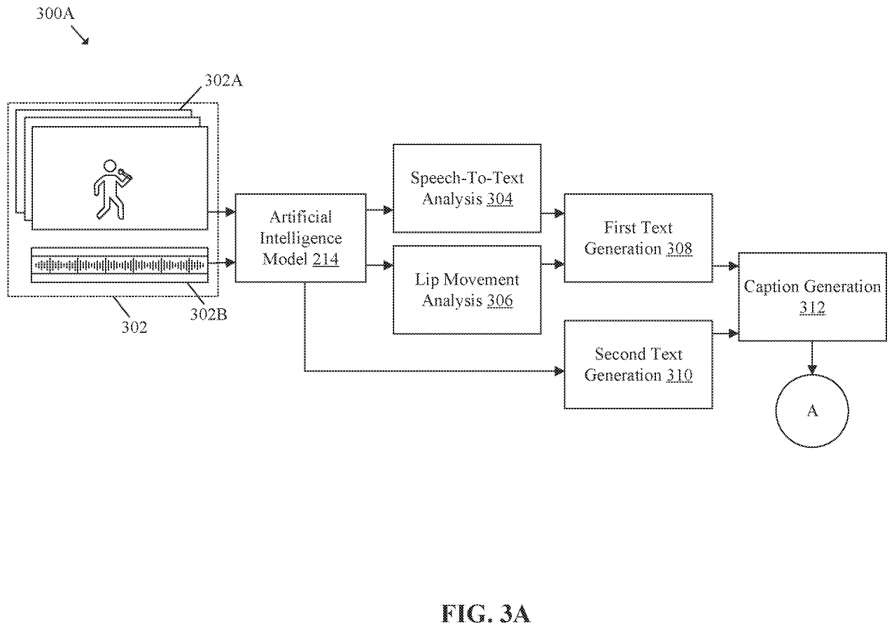

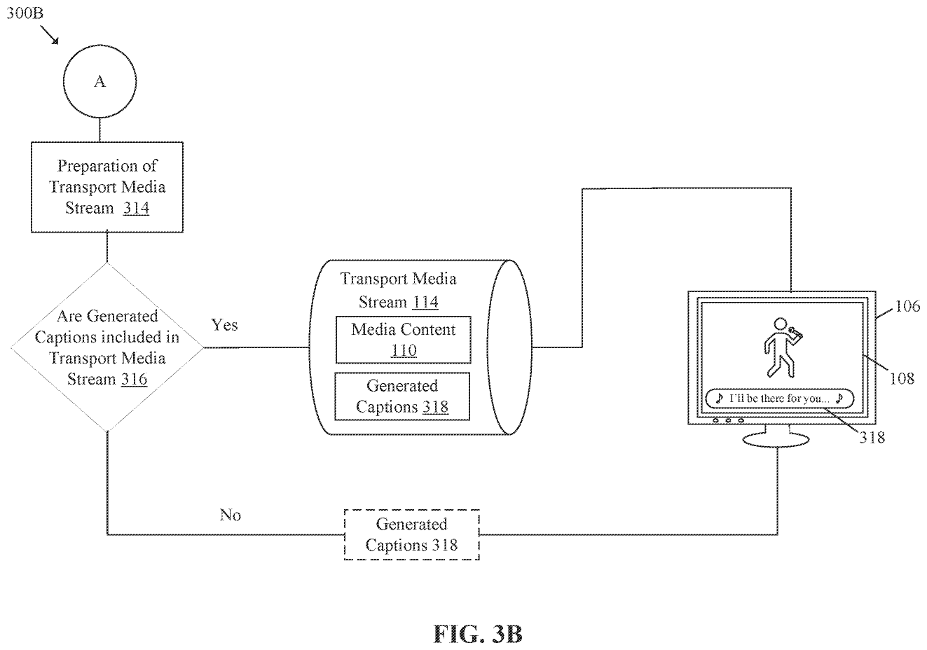

Upon reception, the content distribution system 102 may be configured to generate a first text based on a speech-to-text analysis of the audio content. Details related to the generation of the first text are provided, for example, in FIG. 3. The content distribution system 102 may be configured to further generate a second text that may describe one or more audio elements of a scene associated with the media content. The audio elements may be different from a speech component of the audio content. Details related to the generation of the second text are provided, for example, in FIG. 3. In accordance with an embodiment, operations related to the generation of the first text and the second text may be performed before or at the time the media content is encoded for preparation of a transport media stream.

The content distribution system 102 may be configured to further generate captions for the video content, based on the generated first text and the generated second text. The captions may include a textual representation or a description of various speech elements, such as spoken words or dialogues and non-speech elements such as emotions, face expressions, visual elements in scenes of the video content, or non-verbal sounds. The generation of the captions is described, for example, in FIG. 3. In accordance with an embodiment, to combine both the first text and the second text, the content distribution system 102 may look for gaps or inaccuracies (e.g., word or sentence predictions for which confidence is below a threshold) in the first text and may then fill the gaps or replace portions of the first text with respective portion of the second text, as described, for example in FIG. 3.

The content distribution system 102 may transmit generated captions 112 to the electronic device 106 via an OTA or cable signal or via a streaming Internet connection. In an embodiment, the Over-the-Air (OTA) signal may be a DTV signal (such as an ATSC signal) used to broadcast the generated captions to the electronic device wirelessly via a broadcast station.

In accordance with an embodiment, the content distribution system 102 may be configured to prepare a transport media stream 114 that includes the media content 110. The prepared transport media stream may be transmitted to the electronic device 106 via an OTA or cable signal (same as or different from that used for the captions) or via the streaming Internet connection. The transport media stream 114 may be prepared in a standard format for transmitting and storing media stream digitally. For example, the transport stream 114 may be prepared in accordance with one of Advanced Television Systems Committee (ATSC) standard, Society of Cable Telecommunications Engineers (SCTE), Digital Video Broadcasting (DVB) standard, or Internet protocol television (IPTV) standard.

The generated captions 112 may or may not be included in the transport media stream 114. In an embodiment, the generated captions 112 may be included in the transport media stream 114 and may be formatted in accordance with an in-band caption format. In this case, the generated captions may be transmitted along the audio content and/or the video content of the media stream. For example, ATSC uses CTA-708 (formerly EIA-708 and CEA-708) captions for ATSC DTV streams.

In an embodiment, the generated captions 112 may be excluded from the transport media stream 114 and may be formatted in accordance with an out-of-band caption format. Out-of-band captions may be typically transmitted as a separate file via an OTA or cable signal or the streaming Internet connection.

In an embodiment, the transport media stream 114 may include the media content of a plurality of television channels, and the generated captions 112 may correspond to content included in the media content 110 for each television channel of the plurality of television channels. Media content of each channel of the plurality of channels and the corresponding captions may be combined to prepare the transport stream 114 that may be transmitted to the electronic device 106. Receiver of the electronic device 106 may process and demultiplex the transport stream 114 to determine content and the corresponding generated captions to be played on each television channel.

In an embodiment, the transport media stream 114 includes the media content 110 of a television channel, and the generated captions 112 correspond to the media content 110 of the television channel. In this case, the transport media stream 114 may include the media content 110 and the generated captions 112 of only one television channel.

Upon reception, the electronic device 106 may be configured to control the display device 108 to display the generated captions 112, as described, for example, in FIG. 3. By way of example, and not limitation, the captions may be displayed as an overlay over the video content or within a screen area of the display device 108. The display of such captions may be synchronized based on factors, such as scenes included in the video content, the audio content, and a playback speed and timeline of the video content. In an embodiment, the content distribution system 102 may apply an AI model or a suitable content recognition model on the received media content to generate information, such as metatags or timestamps to be used to display the different components of the generated captions 112 on the display device 108.

The content distribution system 102 may analyze all kinds of visual and non-visual elements depicted in scenes associated with the media content. Such elements may correspond to all kinds of audio-based, video-based, or audio-visual actions or events in the scenes that any viewer may typically observe while viewing the scenes. Such elements are different from elements, such as lip movements in the media (video) content or a speech component of the media content. In an embodiment, the disclosed content distribution system 102 may be configured to determine a portion of the audio content as unintelligible. For example, a speaker may have a non-native or a heavy accent that can be difficult to understand, the audio may be recorded in a noisy environment, or the speaker may not be enunciating properly. The disclosed content distribution system 102 may be configured to generate suitable captions for the determined unintelligible portion of the audio content.

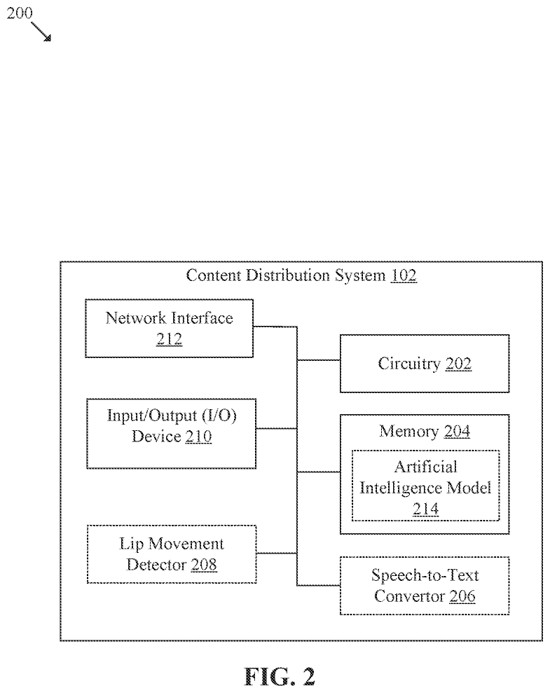

FIG. 2 is a block diagram that illustrates an exemplary content distribution system of FIG. 1, in accordance with an embodiment of the disclosure. FIG. 2 is explained in conjunction with elements from FIG. 1. With reference to FIG. 2, there is shown the content distribution system 102. The content distribution system 102 may include circuitry 202, a memory 204, a speech-to-text convertor 206, a lip movement detector 208, an input/output (I/O) device 210, and a network interface 212. The memory 204 may include an artificial intelligence (AI) model 214. The network interface 212 may connect the content distribution system 102 with the electronic device 106.

The circuitry 202 may include suitable logic, circuitry, and/or interfaces that may be configured to execute program instructions associated with different operations to be executed by the content distribution system 102. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The memory 204 may be configured to store the AI model 214 and the media content. In an embodiment, the memory 204 may store hand-sign symbols associated with a sign language, such as American Sign Language (ASL). Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The AI model 214 may be trained on a task to analyze the video content and/or audio content to generate a text that describes visual elements or non-visual elements (such as non-verbal sounds) in the media content. For example, the AI model 214 may be trained to analyze lip movements in the video content to generate a first text. In an embodiment, the AI model 214 may be also trained to analyze one or more visual elements of a scene associated with the media content to generate a third text. Such elements may be different from lip movements in the video content.

In an embodiment, the AI model 214 may be implemented as a deep learning model. The deep learning model may be defined by its hyper-parameters and topology/architecture. For example, the deep learning model may be a deep neural network-based model that may have a number of nodes (or neurons), activation function(s), number of weights, a cost function, a regularization function, an input size, a learning rate, number of layers, and the like. Such a model may be referred to as a computational network or a system of nodes (for example, artificial neurons). For a deep learning implementation, the nodes of the deep learning model may be arranged in layers, as defined in a neural network topology. The layers may include an input layer, one or more hidden layers, and an output layer. Each layer may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the model. Outputs of each hidden layer may be coupled to inputs of at least one node in other layers of the deep learning model. Node(s) in the final layer may receive inputs from at least one hidden layer to output a result. The number of layers and the number of nodes in each layer may be determined from the hyper-parameters, which may be set before, while, or after training the deep learning model on a training dataset.

Each node of the deep learning model may correspond to a mathematical function (e.g., a sigmoid function or a rectified linear unit) with a set of parameters, tunable during training of the model. The set of parameters may include, for example, a weight parameter, a regularization parameter, and the like. Each node may use the mathematical function to compute an output based on one or more inputs from nodes in other layer(s) (e.g., previous layer(s)) of the deep learning model. All or some of the nodes of the deep learning model may correspond to same or a different mathematical function.

In training of the deep learning model, one or more parameters of each node may be updated based on whether an output of the final layer for a given input (from the training dataset) matches a correct result based on a loss function for the deep learning model. The above process may be repeated for same or a different input till a minima of loss function is achieved, and a training error is minimized. Several methods for training are known in the art, for example, gradient descent, stochastic gradient descent, batch gradient descent, gradient boost, meta-heuristics, and the like.

In an embodiment, the AI model 214 may include electronic data, which may be implemented as, for example, a software component of an application executable on the content distribution system 102. The AI model 214 may include code and routines that may be configured to enable a computing device, such as the content distribution system 102 to perform one or more operations for generation of captions. Additionally, or alternatively, the AI model 214 may be implemented using hardware including, but not limited to, a processor, a microprocessor (e.g., to perform or control performance of one or more operations), a field-programmable gate array (FPGA), a co-processor (such as an AI-accelerator), or an application-specific integrated circuit (ASIC). In some embodiments, the trained AI model 214 may be implemented using a combination of both hardware and software.

In certain embodiments, the AI model 214 may be implemented based on a hybrid architecture of multiple Deep Neural Networks (DNNs). Examples of the AI model 214 may include a neural network model, such as, but are not limited to, an artificial neural network (ANN), a deep neural network (DNN), a convolutional neural network (CNN), a recurrent neural network (RNN), a CNN-recurrent neural network (CNN-RNN), R-CNN, Fast R-CNN, Faster R-CNN, a You Only Look Once (YOLO) network, a Residual Neural Network (Res-Net), a Feature Pyramid Network (FPN), a Retina-Net, a Single Shot Detector (SSD), Natural Language processing and (OCR in some cases) typically use networks, such as CNN-recurrent neural network (CNN-RNN), a Long Short-Term Memory (LSTM) network based RNN, LSTM+ANN, hybrid lip-reading (HLR-Net) model, and/or a combination thereof.

The speech-to-text convertor 206 may include suitable logic, circuitry, interfaces and/or code that may be configured to convert audio information in a portion of audio content to text information. In accordance with an embodiment, the speech-to-text convertor 206 may be configured to generate a first text portion based on the speech-to-text analysis of the audio content. The speech-to-text convertor 206 may be implemented based on several processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), and other processors.

The lip movement detector 208 may include suitable logic, circuitry, interfaces and/or code that may be configured to determine lip movements in the video content. In accordance with an embodiment, the lip movement detector 208 may be configured to generate a second text portion based on the analysis of the lip movements in the video content. The lip movement detector 208 may be implemented based on several processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), and other processors.

The I/O device 210 may include suitable logic, circuitry, interfaces, and/or code that may be configured to receive an input and provide an output based on the received input. The I/O device 210 may include various input and output devices, which may be configured to communicate with the circuitry 202. Examples of the I/O device 210 may include, but are not limited to, a touch screen, a keyboard, a mouse, a joystick, a display device, a microphone, or a speaker.

The network interface 212 may include suitable logic, circuitry, interfaces, and/or code that may be configured to facilitate communication between the content distribution system 102 and the electronic device 106. The network interface 212 may be implemented by use of various known technologies to support wired or wireless communication of the content distribution system 102 with the communication network. The network interface 212 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 212 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). Various operations of the circuitry 202 for generation of captions based on various visual and non-visual elements in content are described further, for example, in FIGS. 3, 4A, 4B, 5, and 6.

FIGS. 3A and 3B are diagrams that illustrates an exemplary processing pipeline for generation of captions based on various visual and non-visual elements in content, in accordance with an embodiment of the disclosure. FIGS. 3A and 3B are explained in conjunction with elements from FIG. 1 and FIG. 2. With reference to FIGS. 3A and 3B, there is shown an exemplary processing pipeline 300A and 300B that illustrates exemplary operations from 304 to 316 for generation of captions. The exemplary operations may be executed by any computing system, for example, by the content distribution system 102 of FIG. 1 or by the circuitry 202 of FIG. 2.

In an operational state, the circuitry 202 may be configured to receive media content 302 from the AV source 104. The media content 302 may include video content 302A and audio content 302B associated with the video content 302A. In an embodiment, the video content 302A may include a plurality of image frames corresponding to a set of scenes included in the media content 302. For example, if the media content 302 is a television program, then the video content 302A may include a performance of character(s) in scenes, a non-verbal reaction of a group of characters in the scene to the performance of the characters, an expression, an action, or a gesture of the character in the scene. Similarly, the audio content 302B may include an interaction between two or more characters in the scene and other audio components, such as audio descriptions, background sound, musical tones, monologue, dialogues, or other non-verbal sounds (such as a laughter sound, a distress sound, a sound produced by objects (such as car, train, buses, or other moveable/immoveable objects), a pleasant sound, an unpleasant sound, a babble noise, or an ambient noise.

At 304, a speech-to-text analysis may be performed on the audio content 302B. In an embodiment, the circuitry 202 may be configured to generate a first text portion based on the speech-to-text analysis. Specifically, the audio content 302B of the received media content 302 may be analyzed and a textual representation of enunciated speech in the received audio content 302B may be extracted using a speech-to-text convertor 206. The generated first text portion may include the extracted textual representation.

In an embodiment, the circuitry 202 may apply a speech-to-text conversion technique to convert the received audio content into a raw text. Thereafter, the circuitry 202 may apply a natural language processing (NLP) technique to process the raw text to generate the first text portion (such as dialogues). Examples of the NLP technique associated with analysis of the raw text may include, but are not limited to, an automatic summarization, a sentiment analysis, a context extraction, a parts-of-speech tagging, a semantic relationship extraction, a stemming, a text mining, and a machine translation. Detailed implementation of such NLP techniques may be known to one skilled in the art; therefore, a detailed description of such techniques has been omitted from the disclosure for the sake of brevity.

At 306, lip movements analysis may be performed. In an embodiment, the circuitry 202 may be configured to generate a second text portion based on the analysis of the lip movements in the video content 302A. In an embodiment, the analysis of the lip movements may be performed based on application of the AI model 214 on the video content 302A. The AI model 214 receive a sequence of image frames (included in the video content 302A) as an input and may detect one or more speakers in each image frame of the sequence of image frames. Further, the AI model 214 may track a position of lips of the detected one or more speakers. Based on the tracking, the AI model 214 may extract lip movement information from the sequence of image frames. In an embodiment, the video content 302A of the received media content 302 may be analyzed using one or more image processing techniques to detect the lip movements and to extract the lip movement information. The AI model 214 may process the lip movement information to generate the second text portion. The second text portion may include dialogues between speakers and other words enunciated or spoken by the one or more speakers in the video content 302A.

At 308, a first text may be generated. In an embodiment, the circuitry 202 may be configured to generate the first text based on at least one of the speech-to-text analysis of the audio content 302B. In an embodiment, the first text may be generated further based on the analysis of the lip movements in the video content 302A. As an example, the generated first text may include the first text portion and the second text portion. Additionally, the generated first text may include markers, such as timestamps and speaker identifiers (for example, names) associated with content of the first text portion and the second text portion. Such timestamps may correspond to a scene and a set of image frames in the video content 302A.

In an embodiment, the circuitry 202 may be configured to compare an accuracy of the first text portion with an accuracy of the second text portion. The accuracy of the first text portion may correspond to an error metric associated with the speech-to-text analysis. For example, the error metric may measure a number of false positive word predictions and/or false negative word predictions against all word predictions or all true positive and true negative word predictions. Detailed implementation of the error metric may be known to one skilled in the art; therefore, a detailed description of the error metric has been omitted from the disclosure for the sake of brevity.

The accuracy of the second text portion may correspond to a confidence of the AI model 214 in a prediction of different words of the second text portion. The confidence may be measured in terms of a percent value between 0% and 100% in generation of the second text portion. A higher accuracy may denote a higher confidence level of the AI model 214. Similarly, a lower accuracy may denote a lower confidence level of the AI model 214. In some embodiments, a threshold accuracy of the first text portion and a threshold accuracy of the second text portion may be set to generate the first text. For example, a first value associated with the accuracy of the first text portion may be 90% and a second value associated with the accuracy of the second text portion may be 80%. Upon comparison of the first value and the second value with a threshold of 85%, the first text may be generated to include only the first text portion.

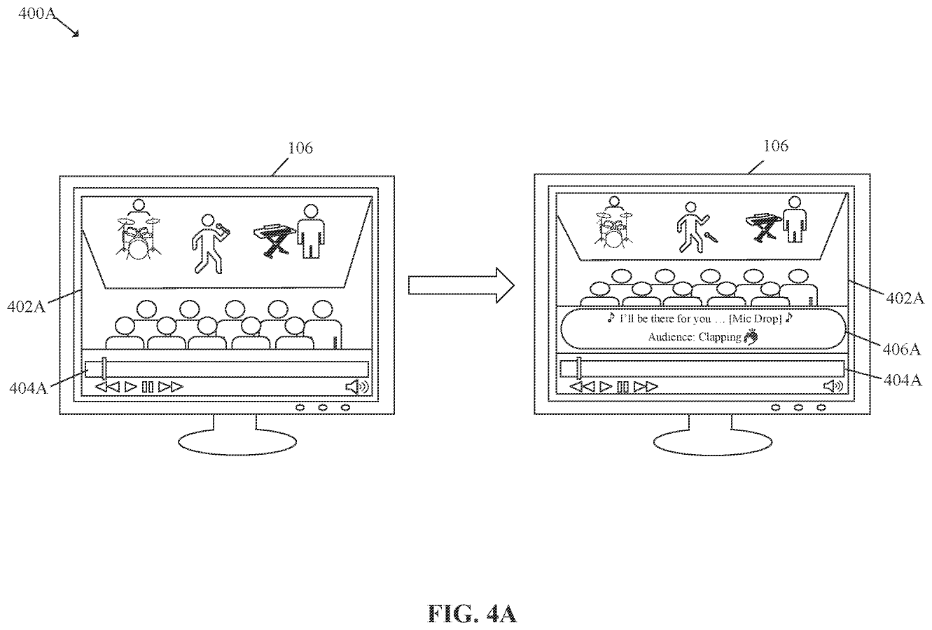

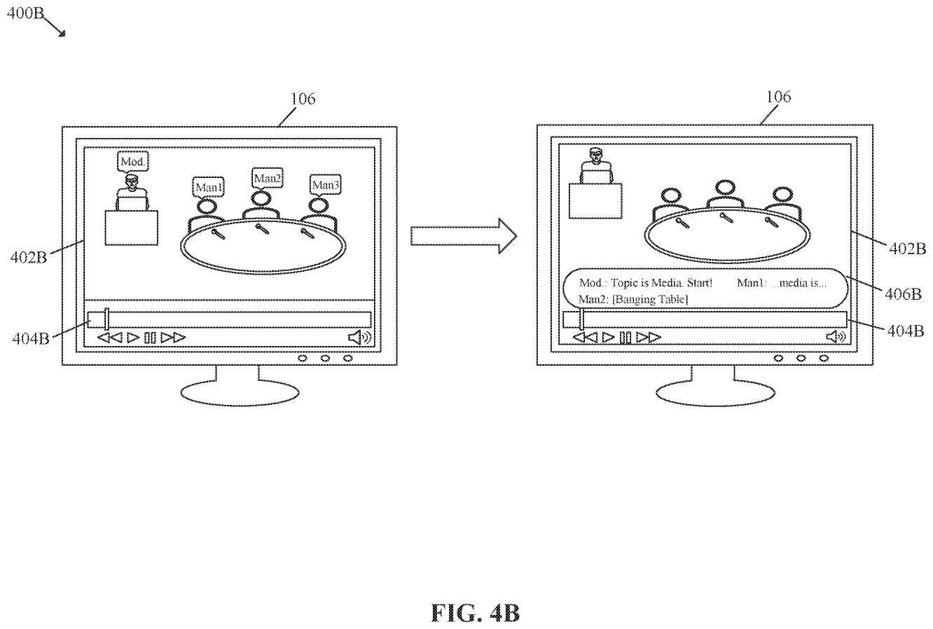

At 310, a second text may be generated. In an embodiment, the circuitry 202 may be configured to generate the second text which describes one or more audio elements of the scene associated with the media content 302. In an embodiment, the second text may be generated based on application of the AI model 214 on the audio content 302B. The one or more audio elements may be different from a speech component of the audio content 302B. As an example, the one or more audio elements may correspond to background sound, musical tones, or other non-verbal sounds (such as a laughter sound, music, a baby crying, a distress sound, a sound produced by objects (such as car, train, buses, or other moveable/immoveable objects), a pleasant sound, an unpleasant sound, a babble noise, or an ambient noise. Different examples related to the one or audio elements are provided, for example, in FIGS. 4A and 4B.

As shown, for example, the video content 302A depicts a person singing a song, and a drummer. Based on the speech-to-text analysis and the lip movement information, the circuitry 202 may be configured to generate the first text to include a portion “I'll be there for you . . . ” of the lyrics of the song. Based on the application of the AI model 214 on at least one of the video content 302A or the audio content 302B, the circuitry 202 may be configured to generate the second text that includes musical notes “Drums Beating”.

In accordance with an embodiment, the AI model 214 may be trained to perform analysis of at least one of the video content 302A or the audio content 302B. Based on the analysis, the AI model 214 may be configured to extract scene information from the video content 302A and/or the audio content 302B. The scene information may include, for example, a scene description, scene character identifiers, character actions, object movement, visual or audio-visual events, interactions between objects, character emotions, reactions to events or actions, and the like. The scene information may correspond to visual elements of one or more scenes in the media content 302 and may be used by the AI model 214 to generate a third text.

In an embodiment, the circuitry 202 may be configured to generate the first text and generate the second text, simultaneously. For instance, the circuitry 202 may be configured to perform speech-to text analysis of the audio content 302B, and analysis of the one or more audio elements (which are different from the speech component of the audio content 302B) simultaneously to generate the first text and the second text, respectively. In such an instance, the media content 302 may correspond to the live media content. Alternatively, the circuitry 202 may be configured to generate the first text and the second text in a sequential manner.

At 312, captions may be generated. In an embodiment, the circuitry 202 may be configured to generate the captions for the video content 302A, based on the generated first text and the generated second text. The generated captions may include dialogues, spoken phrases and words, speaker identifiers for the dialogues and the spoken phrases and words, a description of visual elements in the scenes, and a textual representation of non-verbal (non-speech) sounds in the video content. Such captions may be generated in the same language in which the media content is recorded or in a foreign language. In an embodiment, the generated captions may include a transcription, transliteration, or a translation of a dialogue or a phrase spoken in one or more languages for a specific audience. The captions may include subtitles for almost every non-speech element (e.g., sound generated by different objects and/or persons other than spoken dialogue of a certain person/character in the media content 302).

In an example, the first text generated based on the speech-to-text analysis and the lip movement analysis may include a dialog “Why must this be” by a character. Within the duration in which the dialog is spoken, the audio element in the scene may correspond to an action or a gesture, such as “speaker banging on a podium”. The circuitry 202 may be configured to generate the caption as “Why must this be!”. The exclamation mark may be added to the sentence to emphasize on the strong feeling of the speaker (i.e., the character) in the scene. Another audio element may correspond to an activity of a group of characters, such as students in a lecture hall. The circuitry 202 may be configured to generate the caption as “Why must this be?”. The question mark may be added to the sentence to emphasize on a reaction of the students to the action or the gesture of the speaker. In an example, the audio content 404A may include a screaming sound with dialog SHIT with no trailing ‘T’ in the audio. In such a case, the circuitry 202 may generate the caption as “Shit!”.

In an embodiment, the circuitry 202 may be configured to determine one or more gaps in the generated first text and insert the generated second text based on the detected one or more gaps. Thereafter, the circuitry 202 may be further configured to generate the captions based on the insertion of the generated second text. For example, the first text generated based on the speech-to-text analysis and the lip movement analysis may include a dialog “Pay Attention” by a character. Within the duration in which the dialog is spoken, the audio element in the scene may correspond to an action or a gesture, such as “speaker banging on a podium”. In such a case, the circuitry 202 may be configured to analyze the generated first text to determine one or more gaps in the generated first text. The generated second text (or a portion of the second text) can be inserted in such gaps to generate the captions for the video content 302A. In cases where the generated second text may correspond to a repetitive sound (for example, a hammering sound, a squeaking sound of birds, and the like), the captions may be generated to include the second text periodically.

In an embodiment, the circuitry 202 may be configured to determine timing information corresponding to the generated first text and the generated second text. The timing information may include respective timestamps at which the speech component and the one or more audio elements (which are different from the speech component) may be detected in the media content. Such information may indicate whether the audio elements are present before, after, or in between the speech component. Thereafter, the circuitry 202 may be configured to generate the captions based on the determined timing information. As an example, if the action or the gesture is made before the dialog, the circuitry 202 may be configured to generate the caption as “[Bang on the podium] Pay Attention!”. If the action or the gesture is made after the dialog, the circuitry 202 may be configured to generate the caption as “Pay Attention! [Bang on the podium]”. If the action or the gesture is made in between the dialog, the circuitry 202 may be configured to generate the caption as “Pay [Bang on the podium] Attention!”.

In an embodiment, the circuitry 202 may be configured to analyze the media content to determine that a source of one or more audio elements of the media content is invisible (i.e., not present in the video). For example, if the generated second text corresponds to a squealing sound and the circuitry 202 determines the source of one or more audio elements as invisible, then the captions may include a text that describes both the source and a name of such audio elements. For instance, the squealing sound may be associated with a pig. Based on the analysis of the media content 302, it may be determined that the source (i.e., the pig) of the audio element is invisible. In such a case, the circuitry 202 may be configured to generate the captions to include a text “[Pig squealing]”.

At 314, the circuitry 202 may be configured to prepare the transport media stream 114. The transport media stream 114 may or may not include the generated captions. In an embodiment, the generated captions may be included in the transport media stream 114 and may be formatted in accordance with an in-band captions format. In another embodiment, the generated captions may not be included in the transport media stream 114. In such a case, the captions may be formatted in accordance with an out-of-band captions format and may be transmitted separately as a file to the electronic device 106.

At 316, the circuitry 202 may be configured to determine whether the transport media stream 114 includes the generated captions or not. If the transport media stream 114 includes the generated captions, the transport media stream 114 may be transmitted to the electronic device 106. If the transport media stream does not include the generated captions, then the generated captions may be transmitted to the electronic device 106 separately, as shown by dotted lined in the FIG. 3B.

Upon reception of the captions and the transport media stream, the display device 108 associated with the electronic device 106 may be controlled to display the generated captions. In an embodiment, the circuitry 202 may apply an AI model or a suitable content recognition model on the received media content to generate information, such as metatags or timestamps to be used to display different components of the generated captions on the display device 108 along with the video content 302A. Such information may be provided along with the captions as metadata.

In an embodiment, the AI model 214 may be trained to determine an accuracy of the first text with respect to an accuracy of the second text. In some scenarios, while generating the first text portion, the speech-to-text convertor 206 may miss out on correct analysis of certain portions of the audio content 302B. This may be due to several factors, such as a heavy accent or a non-native accent associated with certain portions of the audio content 302B or a background noise in such portions of the audio content 302B. In such scenarios, the second text portion (corresponding to the lip movements analysis) may be used to correct and improve the content of the first text. Further, the second text (and the third text) may include a description of certain audio, visual, and/or audio-visual elements which are otherwise not captured in the first text. The second text and the third text may enrich content of the first text and the captions 318.

FIG. 4A is a diagram that illustrates an exemplary scenario for generation of captions based on various visual and non-visual elements in content, in accordance with an embodiment of the disclosure. FIG. 4A is described in conjunction with elements from FIGS. 1, 2, and 3. With reference to FIG. 4A, there is shown a scenario 400A. The scenario 400A may include the electronic device 106. There is shown a scene of the media content displayed on the display device 108 associated with the electronic device 106. The scene depicts a concert. A set of operations associated the scenario 400A is described herein.

The circuitry 202 may be configured to receive the media content that includes video content 402A and audio content 404A associated with the video content 402A. The video content 402A may include a set of scenes. As shown, for example, one of the scenes may depict a concert and may include a performance of one or more characters. The scene may also include a group of characters as part of an audience for the performance.

The circuitry 202 may be configured to generate a first text based on a speech-to-text analysis of the audio content 404A, as described, for example, at 304 in FIG. 3. In an embodiment, the first text may be generated further based on the analysis of the lip movements in the video content 402A, as described, for example, at 306 in FIG. 3. The circuitry 202 may be further configured to generate a second text which describes one or more audio elements of the scene(s) associated with the media content. The one or more audio elements may be different from a speech component of the audio content 404A. As shown, for example, there may be one or more audio elements corresponding to a concert (i.e., an event). A first audio element may include an action of a character in the scene, such as singing, drums beating, and playing a piano in the scene. A second audio element may include a gesture of the character, such as a mic drop by the singer in the scene. A third audio element may include a non-verbal reaction, such as an act of clapping by a group of people as a response to the performance of the singer or other performers.

The circuitry 202 may be configured to generate the captions for the video content 402A, based on the generated first text and the generated second text. The circuitry of the electronic device 106 may control the display device 108 associated with the electronic device 106, to display the generated captions. As an example, shown in FIG. 4A, the generated captions 406A may be depicted as “(musical note) I'll be there for you . . . [mic drop] (musical note)”, “Audience: clapping (clap icon)”.

In an embodiment, the circuitry 202 may be configured to generate a third text based on application of an Artificial Intelligence (AI) model (such as the AI model 214) on the video content 402A. The AI model may be applied to analyze one or more visual elements of the video content 402A that may be different from the lip movements. Examples of the one or more visual elements may include, but are not limited to, one or more events associated with a performance of a character in the scene, an expression, an action, or a gesture of the character in the scene, an interaction between two or more characters in the scene, an activity of a group of characters in the scene, a non-verbal reaction, such as an act of clapping by a group of people as a response to the performance of the singer or other performers, or a distress call.

For example, the one or more visual elements may correspond to one or more events (such as a fall from cliff) associated with a performance of a character (such as a person) in the scene. As shown, for example, there may be one or more visual elements corresponding to a concert (i.e., an event). A first visual element may include a performance of a character in the scene, such as a performance by a singer, a drummer, and a pianist in the scene. A second visual element may include an expression, an action, or a gesture of the character, such as a mic drop by the singer in the scene. A third visual element may include a non-verbal reaction of the group of characters such as, clapping by the audience in the scene as a response to the performance of the characters. The third text may include word(s), sentence(s), or phrase(s) that describe or label such visual elements.

FIG. 4B is a diagram that illustrates an exemplary scenario for generation of captions based on various visual and non-visual elements in content, in accordance with an embodiment of the disclosure. FIG. 4B is described in conjunction with elements from FIGS. 1, 2, 3, and 4A. With reference to FIG. 4B, there is shown a scenario 400B. The scenario 400B may include the electronic device 106. There is shown a scene of the media content displayed on the display device 108 associated with the electronic device 106. The scene includes a group of speakers. A set of operations associated the scenario 400B is described herein.

The circuitry 202 may be configured to receive the media content that includes video content 402B and audio content 404B associated with the video content 402B. The video content 402B may include one or more visual elements corresponding to an interaction between two or more characters. As shown, for example, the interaction may include an activity (i.e., a group discussion) between characters in the scene.

In an embodiment, the circuitry 202 may be configured to detect a plurality of speaking characters in the received media content, based on at least one of the analysis of the lip movements in the video content 402B and a speech-based speaker recognition. The plurality of speaking characters may correspond to one or more characters of the scene. In an embodiment, the circuitry 202 may be configured to detect the plurality of speaking characters in the received media content, based on the application of the AI model 214. The AI model 214 may be trained for detection and identification of the plurality of speaking characters in the received media content.

The circuitry 202 may be configured to generate a set of tags based on the detection. Each tag of the set of tags may correspond to an identifier for one of the plurality of speaking characters. For example, the generated set of tags may include “Man 1”, “Man 2”, “Man 3”, “Man 4”, and “Mod” for a first person, a second person, a third person, and a moderator of the group discussion, respectively, in the scene. Alternatively, the tags may include a name of each character, such as the first person, the second person, the third person, and the moderator of the group discussion.

The circuitry 202 may be configured to transmit the generated captions to the electronic device 106 via the Over-the-Air (OTA) or cable signal or via the streaming Internet connection. In an embodiment, the circuitry 202 may prepare transport media stream. The transport media stream may or may not include the generated captions. The prepared transport media stream may be transmitted to the electronic device 106. In case the generated captions are not included in the prepared media stream, the generated captions may be transmitted to the electronic device 106 separately.

The circuitry of the electronic device 106 may control the display device 108 to display the set of tags close to a respective location of the plurality of speakers in the scene. For example, the tags may be displayed to a head of the speaker. The circuitry 202 may be configured to update the captions to associate each portion of the captions with a corresponding tag of the set of tags. As an example, shown in FIG. 4B, the generated captions 406B may be depicted as “Mod: Topic is Media. Start!” “Man 1: . . . media is . . . ” “Man 2: [Banging Table]”

In an example, the circuitry 202 may be configured to color code the detected plurality of speaking characters. for example, captions corresponding to Man 1 may be displayed in red color, captions corresponding to Man 2 may be displayed in yellow color, captions corresponding to Man 3 may be displayed in green color, and captions corresponding to Mod may be displayed in orange color.

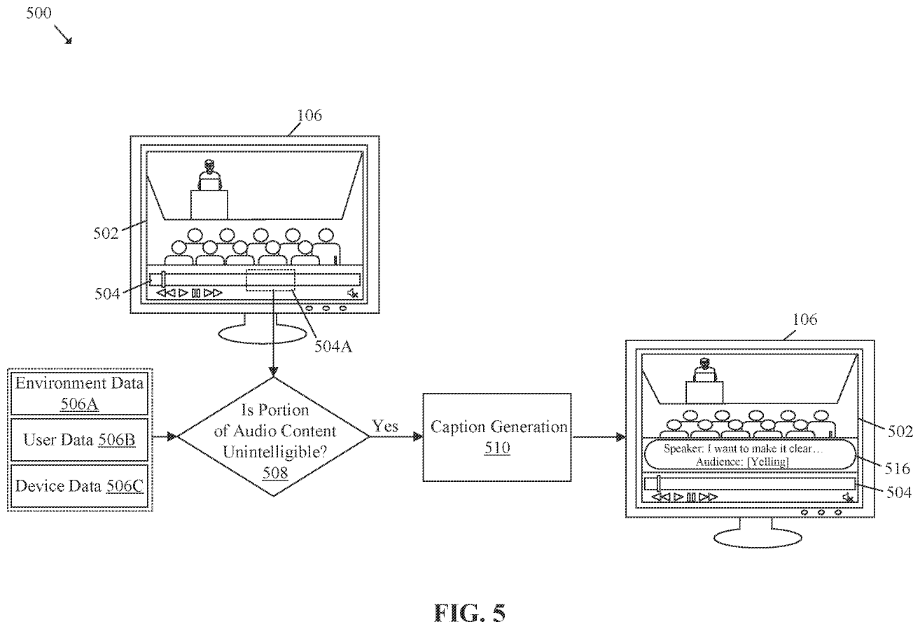

FIG. 5 is a diagram that illustrates an exemplary scenario for generation of captions when a portion of audio content is unintelligible, in accordance with an embodiment of the disclosure. FIG. 5 is described in conjunction with elements from FIGS. 1, 2, 3, 4A, and 4B. With reference to FIG. 5, there is shown an exemplary scenario 500. The exemplary scenario 500 may include the electronic device 106. There is shown a scene of the media content displayed on the display device 108 associated with the electronic device 106. The operations to generate captions when a portion of audio content is unintelligible is described herein.

The circuitry 202 may be configured to receive the media content that includes video content 502 and audio content 504 associated with the video content 502, as described, for example, in FIG. 3. The video content 502 may depict a set of scenes. As shown, for example, one of the scenes includes a speaker standing close to a podium and addressing an audience.

At 508, an unintelligible portion of the audio content may be determined. In an embodiment, the circuitry 202 may be configured to determine a portion 504A of the audio content 504 as unintelligible. The portion 504A of the audio content 504 may be determined as unintelligible based on factors, such as a determination that the portion 504A of the audio content 504 is missing a sound, a determination that the speech-to-text analysis failed to interpret speech in the audio content to a threshold level of certainty, a hearing disability or a hearing loss of a user associated with the electronic device 106, an accent of a speaker associated with the portion 504A of the audio content 504, a loud sound or a noise in a background of an environment that includes the content distribution system 102, a determination that the electronic device 106 is on mute, an inability of the user to hear sound at certain frequencies, and a determination that the portion 504A of the audio content 504 is noisy.

By way of example, and not limitation, the portion 504A of the audio content 504 may be missing from the audio content 504. As a result, the portion 504A of the audio content 504 may be unintelligible to the user. Without the portion 504A, it may not be possible to generate a first text portion, based on a speech-to-text analysis of for the portion 504A. In some instances, it is possible that lips of the speaking character are not visible due to occlusion by certain objects in the scene or due to an orientation of the speaking character (for example, only the back of the speaking character is visible in the scene). In such instances, it may not be possible to generate a second text portion, based on a lip movements analysis.

In an embodiment, the circuitry 202 may fail to interpret speech in the portion 504A of the audio content 504 (while performing the speech-to-text analysis) to a threshold level of certainty. For example, the threshold level of certainty may be 60%, 70%, 75%, or any other value between 0% and 100%. Based on the failure, the portion 504A of the audio content 504 may be determined as unintelligible for the user.

In an embodiment, the accent of a speaker associated with the portion 504A of the audio content 504 may be unintelligible to the user. For example, the speaker may speak English with a French accent or a very heavy accent, and the user may be a British or American, who may be accustomed to British or American accent. The user may, at times, find it difficult to understand the speech of the speaker. As another example, the portion 504A of the audio content 504 may be noisy. For example, the audio content 504 may be recorded around a group of people who may be waiting next to a train track. The audio content may include a train noise, a babble noise due to various speaking characters in background, train announcements, and the like. Such noises may make the portion 504A of the audio content as unintelligible.

In accordance with an embodiment, the portion 504A of the audio content 504 may be determined as unintelligible based on an environment data 506A, a user data 506B, and a device data 506C. The environment data 506A may include information on a loud sound or a noise in the background of the environment that includes the content distribution system 102 and/or the electronic device 106. When the content distributions system 102, generates live captions for live events, such as, the newsroom, the noise may be noise present in the newsroom. In generation of live captions, the noise may often make generation the live caption difficult. The user data 506B may include information associated with the user. For example, the user data 506B may be stored in the user profile associated with the user. The user profile may be indicative of a hearing disability, or a hearing loss of the user associated with the electronic device 106 and of the inability of the user to hear sound at certain frequencies. The device data 506C may include information associated with the electronic device 106. For example, the device data 506C may include the information on whether the electronic device 106 is on mute or not. Such information may be indicated on the display device 108 by a mute option.

In an embodiment, the circuitry 202 may configured to determine the portion 504A of the audio content 504 as unintelligible based on application of the AI model 214 on the audio content 504. For example, the circuitry 202 may fail to generate the first text for the portion 504A of the audio content 504, based on the speech-to-text analysis of the audio content 504. The circuitry 202 may be configured apply the AI model 214 the portion 504A of the audio content 504 to generate the first text as “Indistinct Conversation”, “Conversation cannot be distinguished” or “Indetermined conversation”.

At 510, captions may be generated. In an embodiment, the circuitry 202 may be configured to generate the captions based on a determination that the portion of the audio content is unintelligible. The captions may be generated to include the generated first text and the generated second text in a defined format.

As described in FIG. 3, the first text may be generated based on at least one of the speech-to-text analysis of the audio content 504 and/or the analysis of the lip movements in the video content 502. The second text may be generated based on the application of the AI model 214 and may describe one or more audio elements of the scene associated with the media content. The circuitry may then transmit the media content and the generated captions to the electronic device 106 as described in steps 314 to 316 of FIG. 3B.

The circuitry of the electronic device 106 may be configured to control the display device 108 associated with the electronic device 106, to display the generated captions. As an example, shown in FIG. 5, the generated captions 512 may be depicted as “Speaker: I want to make it clear . . . , Audience: [Yelling]”.

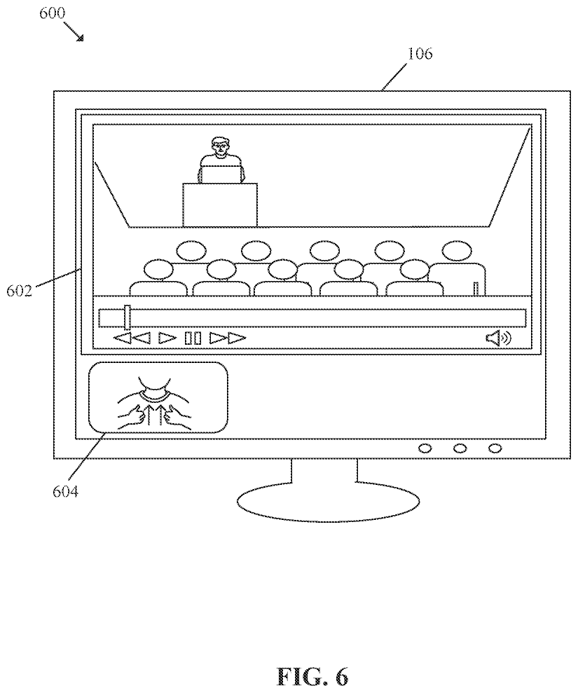

FIG. 6 is a diagram that illustrates an exemplary scenario for generation of hand-sign symbols based on various visual and non-visual elements in content, in accordance with an embodiment of the disclosure. FIG. 6 is described in conjunction with elements from FIGS. 1, 2, 3, 4A, 4B, and 5. With reference to FIG. 6, there is shown an exemplary scenario 600. The exemplary scenario 600 may include an electronic device 106. There is shown a scene of the media content displayed on the display device 108 associated with the electronic device 106. The operations to generate hand-sign symbols based on various visual and non-visual elements is described herein.

The circuitry 202 may be configured to receive the media content 602 that includes video content and audio content associated with the video content, as described, for example, in FIG. 3. The video content may include a set of scenes. As shown, for example, one of such scenes include a speaker standing close to a podium and addressing an audience.

The circuitry 202 may be configured to generate a first text based on at least one of the speech-to-text analysis of the audio content and the analysis of the lip movements in the video content, as described, for example, at 308 in FIG. 3. The circuitry 202 may be further configured to generate a second text which describes one or more visual elements of the scene associated with the media content 602, based on the application of the AI model 214, as described, for example, at 310 in FIG. 3. The circuitry 202 may be configured to generate the captions for the video content, based on the generated first text and the generated second text.

In an embodiment, the circuitry 202 may be configured to determine a hearing disability or hearing loss of the user associated with the electronic device 106 or an inability of the user to hear sound at certain frequencies based on the received user profile associated with the user. In such a case, the circuitry 202 may be configured to generate captions that include hand-sign symbols associated with a sign language, such as American Sign Language (ASL). The captions that include the hand-sign symbols may be generated based on the generated first text and the generated second text. The display device 108 may be controlled to display the generated captions along with the video content. An example of the generated captions 604 is shown.

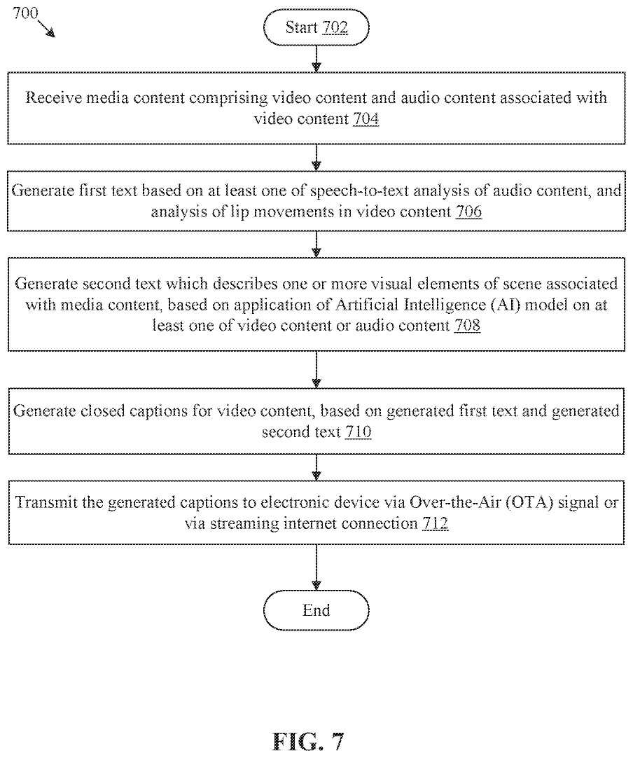

FIG. 7 is a flowchart that illustrates exemplary operations for generation of captions based on various visual and non-visual elements in content, in accordance with an embodiment of the disclosure. FIG. 7 is described in conjunction with elements from FIGS. 1, 2, 3, 4A, 4B, 5, and 6. With reference to FIG. 7, there is shown a flowchart 700. The flowchart 700 may include operations from 702 to 712 and may be implemented by the content distribution system 102 of FIG. 1 or by the circuitry 202 of FIG. 2. The flowchart 700 may start at 702 and proceed to 704.

At 704, media content including video content and audio content associated with the video content may be received. In an embodiment, the circuitry 202 may be configured to receive the media content (for example, the media content 302) including video content (for example, the video content 302A) and audio content (for example, the audio content 302B) associated with the video content 302A. The reception of the media content 302 is described, for example, in FIG. 3.

At 706, a first text may be generated, based on at least one of a speech-to-text analysis of the audio content, and analysis of lip movements in the video content. In an embodiment, the circuitry 202 may be configured to generate the first text based on at least of the speech-to-text analysis of the audio content 302B, and the analysis of lip movements in the video content 302A. The generation of the first text is described, for example, at 308 in FIG. 3.

At 708, a second text which describes one or more audio elements of a scene associated with the media content may be generated based on application of AI model on at least one of the video content or the audio content. In an embodiment, the circuitry 202 may be configured to generate the second text which describes the one or more audio elements of the scene. The one or more audio elements may be different from a speech component of the audio content 302B. The generation of the second text is described, for example, at 310 in FIG. 3.

At 710, captions for the video content may be generated, based on the generated first text and the generated second text. In an embodiment, the circuitry 202 may be configured to generate the captions (for example, the captions 318) for the video content 302A, based on the generated first text and the generated second text. The generation of the captions 318 is described, for example, in FIG. 3.

At 712, the generated captions 318 may be transmitted to the electronic device 106 via an OTA or cable signal or via a streaming Internet connection. In an embodiment, the circuitry 202 may be configured to prepare the transport media stream and transmit the prepared transport media stream to the electronic device 106. The prepared transport media stream may or may not include the generated captions 318. In case the transport media stream does not include the generated captions 318, the generated captions 318 may be transmitted separately. Control may pass to end.

Although the flowchart 700 is illustrated as discrete operations, such as 704, 706, 708, 710, and 712, the disclosure is not so limited. Accordingly, in certain embodiments, such discrete operations may be further divided into additional operations, combined into fewer operations, or eliminated, depending on the implementation without detracting from the essence of the disclosed embodiments. Various embodiments of the disclosure may provide a non-transitory computer-readable medium and/or storage medium having stored thereon, computer-executable instructions executable by a machine and/or a computer to operate a content distribution system (for example, the content distribution system 102). Such instructions may cause the content distribution system 102 to perform operations that include retrieval of media content (for example, the media content 302) including video content (for example, the video content 302A) and audio content (for example, the audio content 302B) associated with the video content 302A. The operations may further include generate a first text based on at least one of a speech-to-text analysis of the audio content 302B. The operations may further include generation a second text which describes one or more audio elements of a scene associated with the media content 302. The one or more audio elements may be different from a speech component of the audio content 302B. The operations may further include generation of captions (for example, the captions 318) for the video content 302A, based on the generated first text and the generated second text. The operations may further include transmit the generated captions 318 to the electronic device 106 via the Over-the-Air (OTA) or cable signal or via the streaming Internet connection.

Exemplary aspects of the disclosure may provide a content distribution system (such as, the content distribution system 102 of FIG. 1) that includes circuitry (such as, the circuitry 202). The circuitry 202 may be configured to receive media content (for example, the media content 302) including video content (for example, the video content 302A) and audio content (for example, the audio content 302B) associated with the video content 302A. The circuitry 202 may be further configured to generate a first text based on at least one of a speech-to-text analysis of the audio content 302B. The circuitry 202 may be further configured to generate a second text which describes one or more audio elements of a scene associated with the media content 302. The one or more audio elements may be different from a speech component of the audio content 302B. The circuitry 202 may be further configured to generate captions (for example, the captions 318) for the video content 302A, based on the generated first text and the generated second text. The circuitry 202 may be further configured to control transmission of the generated captions to the electronic device 106 via the Over-the-Air (OTA) or cable signal or via the streaming Internet connection.

In an embodiment, the first text is generated further based on an analysis of lip movements in the video content 302A.

In an embodiment, the analysis of the lip movements may be based on application of the AI model 214 on the video content 302A.

In an embodiment, the generated first text may include a first text portion that is generated based on the speech-to-text analysis, and a second text portion that is generated based on the analysis of the lip movements.

In an embodiment, the circuitry 202 may be configured to compare an accuracy of the first text portion with an accuracy of the second text portion. The circuitry 202 may be further configured to generate the captions 318 based on the comparison.

In an embodiment, the accuracy of the first text portion may correspond to an error metric associated with the speech-to-text analysis, and the accuracy of the second text portion may correspond to a confidence of the AI model 214 in a prediction of different words of the second text portion.

In an embodiment, the second text is generated further based on application of an Artificial Intelligence (AI) model on the audio content.

In an embodiment, the circuitry 202 is further configured to prepare a transport media stream 114 that includes the media content 110 and transmit the prepared transport media stream to the electronic device 106 via the OTA or cable signal or via the streaming internet connection.

In an embodiment, the generated captions 112 are included in the transport media stream 114 and are formatted in accordance with an in-band caption format.

In an embodiment, the generated captions 112 are excluded from the transport media stream and are formatted in accordance with an out-of-band caption format.

In an embodiment, the transport media stream 114 includes the media content of a plurality of television channels, and the generated captions 112 correspond to content included in the media content for each television channel of the plurality of television channels.

In an embodiment, the transport media stream 114 includes the media content of a television channel, and the generated captions 112 correspond to the media content of the television channel.

In an embodiment, the transport media stream 114 is prepared in accordance with one of Advanced Television Systems Committee (ATSC) standard, a Society of Cable Telecommunications Engineers (SCTE), a Digital Video Broadcasting (DVB) standard, or an Internet Protocol Television (IPTV) standard.

In an embodiment, the generated captions 604 include hand-sign symbols in a sign language to describe the generated first text and the generated second text.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A content distribution system, comprising:
circuitry configured to:
receive media content comprising video content and audio content associated with the video content;
generate a first text based on a speech-to-text analysis of the audio content;
generate a second text which describes one or more audio elements of a scene associated with the media content,
wherein the one or more audio elements are different from a speech component of the audio content;
generate captions for the video content, based on the generated first text and the generated second text; and
transmit the generated captions to an electronic device via an Over-the-Air (OTA) signal, via a cable, or via a streaming Internet connection.

2. The content distribution system according to claim 1, wherein the first text is generated further based on an analysis of lip movements in the video content.

3. The content distribution system according to claim 2, wherein the analysis of the lip movements is based on application of an Artificial Intelligence (AI) model on the video content.

4. The content distribution system according to claim 2, wherein the generated first text comprises:
a first text portion that is generated based on the speech-to-text analysis, and
a second text portion that is generated based on the analysis of the lip movements.

5. The content distribution system according to claim 4, wherein the circuitry is further configured to:
compare an accuracy of the first text portion with an accuracy of the second text portion; and
generate the captions further based on the comparison.

6. The content distribution system according to claim 5, wherein the accuracy of the first text portion corresponds to an error metric associated with the speech-to-text analysis and,
the accuracy of the second text portion corresponds to a confidence of the AI model in a prediction of different words, including words describing sound, of the second text portion.

7. The content distribution system according to claim 1, wherein the second text is generated further based on application of an Artificial Intelligence (AI) model on the audio content.

8. The content distribution system according to claim 1, wherein the circuitry is further configured to:
prepare a transport media stream that includes the media content; and
transmit the prepared transport media stream to the electronic device via the OTA signal, via the cable, or via the streaming Internet connection.

9. The content distribution system according to claim 8, wherein the generated captions are included in the transport media stream and are formatted in accordance with an in-band caption format.

10. The content distribution system according to claim 8, wherein the generated captions are excluded from the transport media stream and are formatted in accordance with an out-of-band caption format.

11. The content distribution system according to claim 8, wherein the transport media stream includes the media content of a plurality of television channels, and
the generated captions correspond to content included in the media content for each television channel of the plurality of television channels.

12. The content distribution system according to claim 8, wherein the transport media stream includes the media content of a television channel, and
the generated captions correspond to the media content of the television channel.

13. The content distribution system according to claim 8, wherein the transport media stream is prepared in accordance with one of Advanced Television Systems Committee (ATSC) standard, a Society of Cable Telecommunications Engineers (SCTE), a Digital Video Broadcasting (DVB) standard, or an Internet Protocol Television (IPTV) standard.

14. The content distribution system according to claim 1, wherein the generated captions include hand-sign symbols in a sign language to describe the generated first text and the generated second text.

15. A method, comprising:
receiving media content comprising video content and audio content associated with the video content;
generating a first text based on a speech-to-text analysis of the audio content;
generating a second text which describes one or more audio elements of a scene associated with the media content,
wherein the one or more audio elements are different from a speech component of the audio content;
generating captions for the video content, based on the generated first text and the generated second text; and
transmitting the generated captions to an electronic device via an Over-the-Air (OTA) signal, via a cable, or via a streaming Internet connection.

16. The method according to claim 15, wherein the first text is generated further based on an analysis of lip movements in the video content.

17. The method according to claim 16, wherein the analysis of the lip movements is based on application of an Artificial Intelligence (AI) model on the video content.

18. The method according to claim 15, wherein the generating the first text further comprises:
generating a first text portion based on the speech-to-text analysis, and
generating a second text portion based on the analysis of lip movements.

19. The method according to claim 18, further comprising:
comparing an accuracy of the first text portion with an accuracy of the second text portion; and
generating the captions further based on the comparison.

20. A non-transitory computer-readable medium having stored thereon, computer-executable instructions that when executed by a content distribution system, causes the content distribution system to execute operations, the operations comprising:
receiving media content comprising video content and audio content associated with the video content;
generating a first text based on a speech-to-text analysis of the audio content;
generating a second text which describes one or more audio elements of a scene associated with the media content,
wherein the one or more audio elements are different from a speech component of the audio content;
generating captions for the video content, based on the generated first text and the generated second text; and
transmitting the generated captions to an electronic device via an Over-the-Air (OTA) signal, via a cable, or via a streaming Internet connection.
